(19) United States
(12) Patent Application Publication
(10) Pub. No.: US 2016/0065046 A1
(43) Pub. Date: Mar. 3, 2016

(54) METHOD AND CIRCUITS FOR DIMINISHING DC OFFSET

(71) Applicant: John Alan GIBSON, Richmond Hill (CA)

(72) Inventor: John Alan GIBSON, Richmond Hill (CA)

(21) Appl. No.: 14/472,486

(22) Filed: Aug. 29, 2014

(51) Int. Cl. H02M 1/08

(52) U.S. Cl. CPC H02M 1/08

(57) ABSTRACT

A method and circuit is disclosed for diminishing the DC offset or AC unbalance in an AC load driven by a phase control switch type controller. The method consist of two parts, which may act singly or in concert. The method and circuit of the invention first reduces asymmetry between positive and negative half cycle gating and secondly obtains the amount of DC offset presented to the load, stores that information, and then utilizing the stored information adjusts the function of the controller to diminish the DC offset to a low value by causing causes positive and negative half cycles of the load power to be substantially identical positive and negative half cycles of the load power to be substantially identical. One or more circuits may be provided to reduce the asymmetry of the phase gating circuit, and one or more circuits may be provided to capture the DC offset, allowing correction of the switch output to substantially cancel the unbalance.

### FIELD OF THE INVENTION

The present invention relates to loads, e.g. transformers, motors, or lighting driven by alternating current (AC). More particularly, the present invention relates to phase control or phase back switch type controllers which modulate power to the load by adjusting the voltage ‘turn-on’ point in each half cycle of an AC power supply.

### BACKGROUND OF THE INVENTION

Asymmetric or uneven operation of an AC electronic controller—such as may be brought about by slight physical differences in the forward and reverse voltage and/or ‘turn-on’ and ‘turn-off’ characteristics of electronic switches such as triacs or similar differences in components that are used in turning on (gating) the electronic switches, will cause a DC component to appear at the load. This is commonly known as “DC offset.”

Symmetrical waveforms that have equal components above and below their average centerlines are comprised of only odd-numbered harmonics. Asymmetrical operation yields a current waveform with a greater variety of harmonic frequencies. Asymmetrical waveforms contain even-numbered harmonics which may or may not be accompanied by odd-numbered harmonics. Another definition for DC offset is those AC wave forms which contain even-numbered harmonics.

DC offset often causes undesirable effects in the load. These effects may include increased current flow, increased audible noise (cogging), increased heating or increased flicker in the load. In addition, DC offset in the load will cause DC offset in the mains. DC offset in the mains causes difficulties in other equipment connected to the supply line. These difficulties can include galvanic corrosion, excessive heating of distribution transformers, failure of distribution transformers, errors in electricity metering, compromise of protection relaying, and overheating of neutrals.

The effects DC offset are the subject of a study “DC injection into Low Voltage Networks” conducted by the University of Strathclyde (“the UofS study”) published in 2005, which is incorporated herein by reference. They found very little published information on the impact of DC offset. From effort done in the study, the authors conclude a DC offset limit of 40 mA per household should be implemented. In another part of the study, DC offset injected by individual lighting dimmers was shown to be well in excess of 40 mA.

Underwriters Laboratories Standard UL 1917 “Solid State Fan Speed Controls”: Section 22 “DC Offset Voltage Test” requires that a test be done for the controls covered by the standard and limits the DC offset level to 2 volts throughout the range of operation of the controller. It should be noted that this UL test for DC offset may be the only North American standard which requires compliance of DC offset to less than a prescribed level. If this 2 volt DC offset level is applied to, for example, a system of triac-type speed control driving a 5 A range hood motor having 16 ohms typical winding resistance, the DC offset introduced into the mains would be 125 mA. In addition, a humming noise level in the range hood became sufficiently pronounced to be very annoying.

As can be seen, a controller conforming to the UL requirements exceeds the recommendations of the UofS study. European Parliament Directive 2009/125/EC lays out a framework for issuing regulations regarding Energy Related Products. Regulation 547/2012 specifically addresses the requirements for implementation, beginning in 2013, of variable speed controls for domestic pumps and fans. The regulation is expected to reduce energy consumption in these areas by around 14%.

The most likely format for this speed control implementation is the use of AC permanent split capacitor (PSC) motors. It is therefore desirable and expedient to have method and circuit that will reduce the level of DC offset both injected into the mains from motor speed controls, wall dimmers and solid state power supplies and to provide an efficient, inexpensive means of reducing DC offset for controllers used to power PSC motors.

U.S. Pat. No. 5,585,713 to Crane et al. titled “Light Dimmer Circuit with Control Pulse Stretching” deals with DC offset as applicable to controls supplied by the mains. However, this patent does not teach any specific action taken to either measure the DC offset or specifically remedy DC offset if present. The circuit as described, because of its lack of active remediation of DC offset, could easily exceed the stated one percent DC offset by asymmetries in the triac or silicon-controlled rectifiers (SCRs) used for main power switching, regardless of how accurately the gating symmetry may be maintained. Further, it is questionable whether the gating symmetry is assured over the operating temperature range for such controls, as the complex synchronization and triac gating circuit taught by Crane et include a multitude of temperature-dependent junctions, any one of which could create an asymmetry between positive and negative half-wave triggering.

### BRIEF DESCRIPTION OF THE DRAWINGS

In drawings which illustrate by way of example only a preferred embodiment of the invention,

FIG. 1 is a block diagram of a prior art open loop phase control switch type controller for an AC load.

FIGS. 2a, 2b and 2c are graphical representations of controller voltage and current output waveforms showing: in FIG. 2a, equal positive and negative half wave output zero DC offset; in FIG. 2b, larger positive half wave output positive DC offset; and in FIG. 2c, larger negative half wave output negative DC offset.

FIG. 3 is a block diagram of a prior art open loop phase control switch type controller for an AC load with output feedback.

FIG. 4 is a block diagram of a circuit according to the invention providing unbalance correction using DC Offset Information.

FIG. 5 is a block diagram of a circuit according to the invention providing unbalance correction using gating symmetry.

FIG. 6 is a block diagram of a circuit according to the invention providing unbalance correction using offset correction and gating symmetry.

FIG. 7 is a schematic diagram of the prior art circuit of FIG. 1,

FIG. 8 is a schematic diagram of a circuit according to the invention providing unbalance correction using phase control switch voltage information,

FIG. 9 is a schematic diagram of a circuit according to the invention providing unbalance correction using gating symmetry,

FIG. 10 is a schematic diagram of a circuit according to the invention providing unbalance correction using both switch voltage and gating symmetry,

FIGS. 11a, 11b and 11c are schematic diagrams of circuits showing examples of alternate gate trigger electronics, showing: in FIG. 11a a bilateral switch inside a diode bridge; in FIG. 11b a unilateral switch inside a diode bridge; and in FIG. 11c a programmable unijunction transistor inside a diode bridge.

FIG. 12 is a schematic diagram of a circuit according to the invention providing unbalance correction using load voltage information.

FIG. 13 is a schematic diagram of a circuit according to the invention providing unbalance correction using current information.

FIG. 14 is a schematic diagram of a microcontroller embodiment of the invention using phase control switch voltage information.

FIG. 15 is a schematic diagram of a microcontroller embodiment of the invention using load voltage information.

FIG. 16 is a schematic diagram of a microcontroller embodiment of the invention using current information.

### DETAILED DESCRIPTION OF THE INVENTION

The invention provides an efficient, inexpensive means of reducing DC offset for phase control switch type AC controllers (PCSTAC controllers); minimizes DC offset over the operating temperature range of a PCSTAC controller; minimizes DC offset over the operating voltage range of a PCSTAC controller; and minimizes DC offset without pre-selection of components for a PCSTAC controller. The invention further actively obtains information about any DC offset present in a PCSTAC controller and can utilize said information to reduce DC offset to minimal values.

The invention accordingly provides a method and circuit for diminishing the DC offset in an AC load driven by an electronic controller.

According to the method of the invention, information on the amount of DC offset presented to the load is captured and stored, and the stored information is then used in a manner that adjusts the function of the controller to diminish the DC offset to a low value. The method of the invention serves to minimize asymmetry in the gating function and controller output unbalance causing DC offset.

Circuit devices are provided which comprise means for correcting asymmetry in the gating function and sensing controller output unbalance causing DC offset, and to apply a correction signal modifying the switch output so as to diminish or cancel the unbalance.

The particular embodiments of the invention as described are for use with single phase permanent split capacitor induction motors (PSC motors), where the invention is most advantageously implemented. However, it will be appreciated that the principles of the invention apply to other AC loads, including single phase or poly-phase systems for motors, transformers, lighting, resistors, or other loads driven by this type of phase back controller, and the invention is not limited to any specific type of AC load or environment.

The invention thus provides a method for diminishing a DC offset in an AC load driven by a phase control switch type alternating current controller comprising a phase control switch and a phase gating device, comprising the steps of: a. obtaining information representing DC offset present in the load; b. storing a value representing the DC offset; and c. adjusting the controller to lower the DC offset in the load by applying a correcting signal to the phase gating device to thereby adjust phase gating timing to approach a substantial match between the power in the positive and negative half cycles of the load supply.

The invention further provides a phase control switch type alternating current controller circuit for diminishing an amount of DC offset present in a load, comprising: a phase controlled switch comprising a TRIAC having: a first electrode connected to an AC power supply and through an AC supply synchronizing component to a gating device comprising a variable resistor, a second electrode connected through a DIAC to a first side of the variable resistor and hence through the other side of the variable resistor to the AC supply synchronizing component to the first electrode, and a third electrode connected through a capacitor to the second electrode via a node between the DIAC and the first side of the variable resistor and to an input of the load, and a feedback circuit for obtaining and storing a value representing the DC offset, having inputs connected to the first electrode and to the input of the load and an output connected to the first side of the variable resistor, whereby timing of the gate signal causes positive and negative half cycles of the load power to be substantially identical and hence diminishes the DC offset.

The invention further provides a phase control switch type alternating current controller circuit for diminishing an amount of DC offset present in a load, comprising: a phase controlled switch comprising a TRIAC having: a first electrode connected to an input to a load and through an AC supply synchronizing component to a gating device comprising a variable resistor, a second electrode connected through a DIAC to a first side of the variable resistor and hence through the other side of variable resistor to the AC supply synchronizing component to the first electrode, and a third electrode connected through a capacitor to the second electrode via a node between the DIAC and the first side of the variable resistor and to an AC power supply, and a feedback circuit for obtaining and storing a value representing the DC offset, having inputs connected to the first electrode and to the input of the load and an output connected to the first side of the variable resistor, whereby timing of the gate signal causes positive and negative half cycles of the load power to be substantially identical and hence diminishes the DC offset.

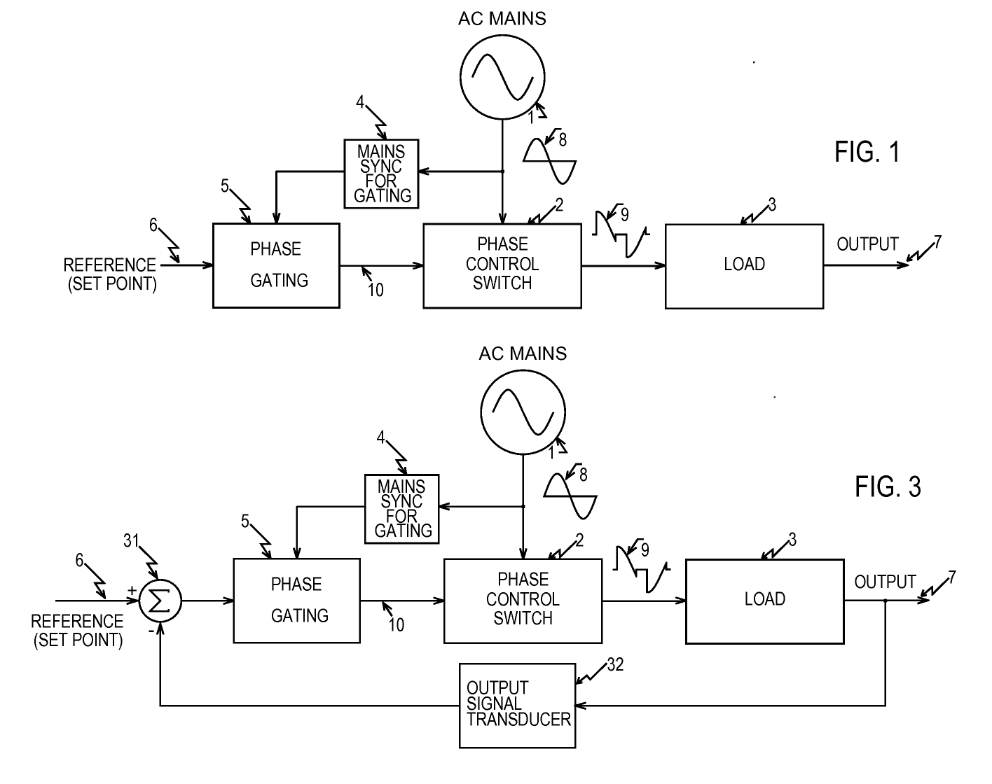

The invention enables a material reduction in the amount of DC offset that is presented to the load by the controller, and DC offset injection into the mains. FIG. 1 is a block diagram of a simple open loop phase control switch type controller which is well known in the prior art. Referring to the diagram, the following identifications are provide for the blocks and their function:
1 AC supply of electrical power (mains);
2 Phase control switch to supply phase controlled power to the load 3;
3 Load (or process) being controlled;
4 Mains synchronization for phase gating;
5 Phase gating to supply turn-on signal to phase control switch 2;
6 Reference or set point for providing desired output level information to 5;
7 Output of the load or process;
8 Input voltage waveform to phase controlled switch;
9 Output voltage waveform to load; and
10 Turn-on (gate) signal to phase control switch 2.

Any phase controlled switch configuration could be used for 2, which could include, but is not limited to, a TRIAC, alternistor, antiparallel SCRs, SCR in a diode bridge, opposed SCRs with antiparallel diodes, or photoactivated thyristors.

The system illustrated in FIG. 1 is “open loop” in that there is no feedback from 7, the final output of 3, the process to 6, the reference or the set point. Consequently, a change in, say, input voltage will cause a change to 7, the output of which will not be corrected until a change in 6, the set point, has been made.

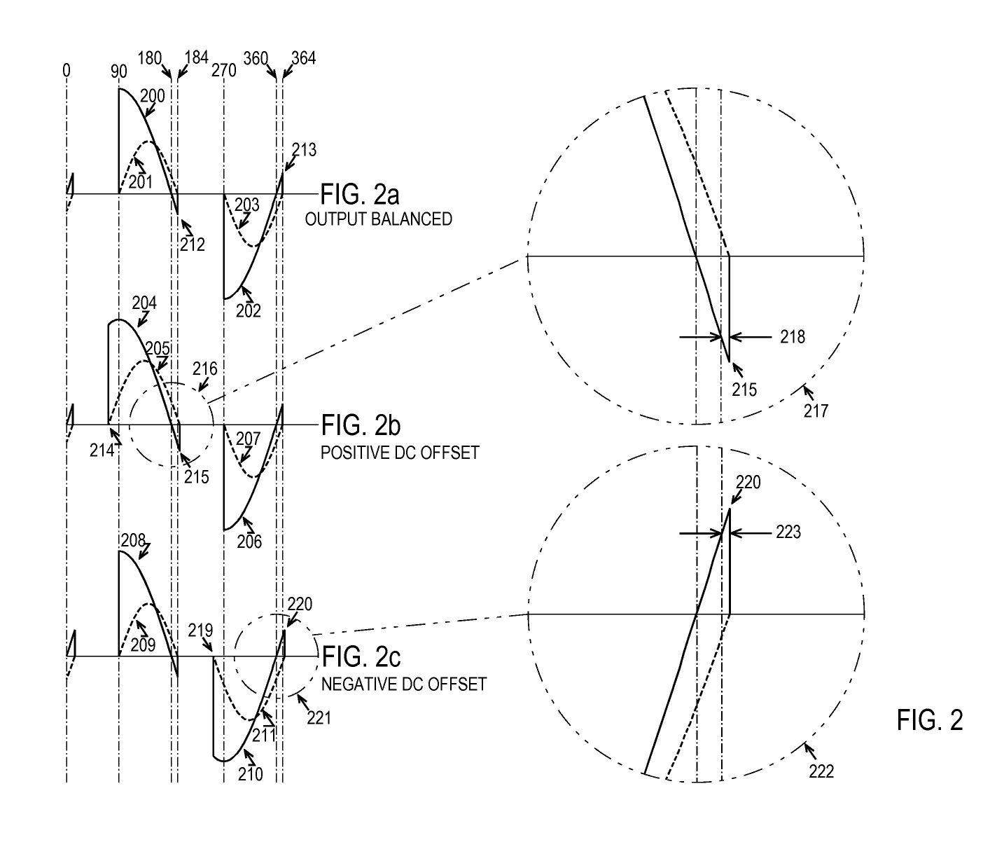

FIGS. 2a, 2b and 2c illustrate waveforms of load voltage and load current over slightly more than a single AC cycle of what might be observed in a device operating as FIG. 1 after it is in a steady state. These waveforms have been drawn to scale and are aligned vertically along dotted-dashed lines for easy visual comparisons to be made among the three conditions of unbalance or DC offset illustrated. Voltage waveforms and the horizontal time axis are shown as solid lines and current waveforms are shown as dashed lines.

Unbalance or DC offset occurs when the area bounded by the waveform and the horizontal axis (area under the curve) for the “positive” half wave is different to the area bounded by the waveform and horizontal axis (area under the curve) of “negative” half wave. When the areas under the curve for “positive” and “negative” half waves are equal, the system is balanced and there is no DC offset.

FIG. 2a represents a balanced output with no DC offset. In FIG. 2a, the “positive” load voltage waveform 200 turns ‘on’ at line 90 which causes the current to be as 201. The voltage 200 stays on until the current reaches zero at line 184, at which point the voltage wave 200 is at 212 and somewhat negative. This negative component 212 of the “positive” voltage wave is the consequence of line commutated phase control switches supplying loads having an inductive component. In such cases current 201 continues to flow in the same direction until sufficient energy has been returned from the inductive component back to the supply that the current reaches zero, at which point the switch turns ‘off.’

During the time the voltage wave and current wave are both positive, between lines 90 and 180, power is being delivered to the load. During the time current is still positive and the voltage is negative, between lines 180 and 184, power is being returned to the supply from the load. It can be seen that the positive cross product of the areas above the horizontal axis line, between 90 and 180, is far larger than the negative cross product of the waveforms between 180 and 184, so net power is delivered to the load.

At line 270 the “negative” load voltage 202 comes ‘on,’ causing the current to be as at 203. During the time the voltage wave 202 and current wave 203 are both negative, between lines 270 and 360, power is being delivered to the load since the product of the two negative values is positive). During the time current 203 is still negative and voltage 202 is positive 213, between lines 360 and 364, power is being returned to the supply from the load. This condition ends at line 364 when current 203 again reaches zero.

It can thus be seen that all values of the “positive” 200 and 201 waveforms and “negative” 202 and 203 waveforms are of equal magnitude but of opposite polarity, and hence balanced so there is no DC offset.

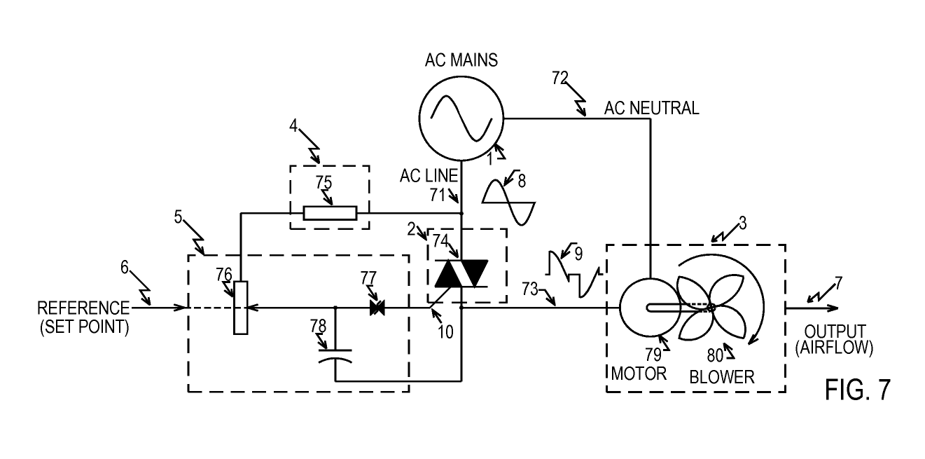

FIG. 2b is a representation of an asymmetric gating of the phase control switch that yields positive DC offset. FIG. 2b illustrates the impact of an earlier phase trigger (lower breakover voltage of diac 77 FIG. 7) in its “positive” direction together with a later phase trigger (higher breakover voltage of diac 77) in its “negative” direction. The “negative” trigger has been adjusted to make the “negative” waveforms 206 and 207 identical to the “negative” waveforms 202 and 203 of FIG. 2a.

The on-time period of “positive” load voltage waveform 204 is longer than 200 above, as the turn-on occurs at 214, somewhat before 90 and lasts until 215. The current response to this earlier turn on is represented by dashed line 205. Line 205 is both wider from 214 to 215 and higher than 201. The expansion of circle 216 to 217 represents a fourfold increase. An increase of negative voltage component is marked as 218. It can also be seen the area under voltage wave 204 is greater than the area under voltage wave 206 and current wave 205 is greater than the area under current wave 207, which means there is an unbalance on the positive side and hence a positive DC offset for both voltage and current.

FIG. 2c is a representation of an asymmetric gating of the phase control switch that yields a negative DC offset. FIG. 2c illustrates the impact of an earlier phase trigger (lower breakover voltage of diac 77) in its “negative” direction together with a later phase trigger (higher breakover voltage of diac 77) in its “positive” direction. The “positive” trigger has been adjusted to make the “positive” waveforms 208 and 209 identical to the “positive” waveforms 200 and 201 of FIG. 2a.

The on-time period of “negative” load voltage waveform 210 is longer than 202 above, as the turn-on occurs at 219, somewhat before 270 and lasts until 220. The current response to this earlier turn-on is represented by dashed line 211. Line 211 is both wider from 219 to 220 and higher than 203. The expansion of circle 221 to 222 represents a fourfold increase. An increase of negative voltage component is marked as 223. It can be seen the area under voltage wave 210 is greater than the area under voltage wave 208 and the area under current wave 211 is greater than the area under current wave 209, which means there is negative DC offset for both voltage and current.

FIG. 3 is a block diagram of the open loop control system of FIG. 1, made into a closed loop system by adding a reference and feedback signal summation point 31 and a transducer 32 for output 7. A “closed loop” system, as shown in FIG. 3, has means of sensing the output 7, in this embodiment via output signal transducer 32, and the output of transducer 32 is fed back to the input reference summation point 31. This feedback maintains the output virtually equal to the set point 6 command. The operation of such closed loop systems is well known to those skilled in the art. Such a system could be implemented by adding a feedback loop to a system incorporating the present invention.

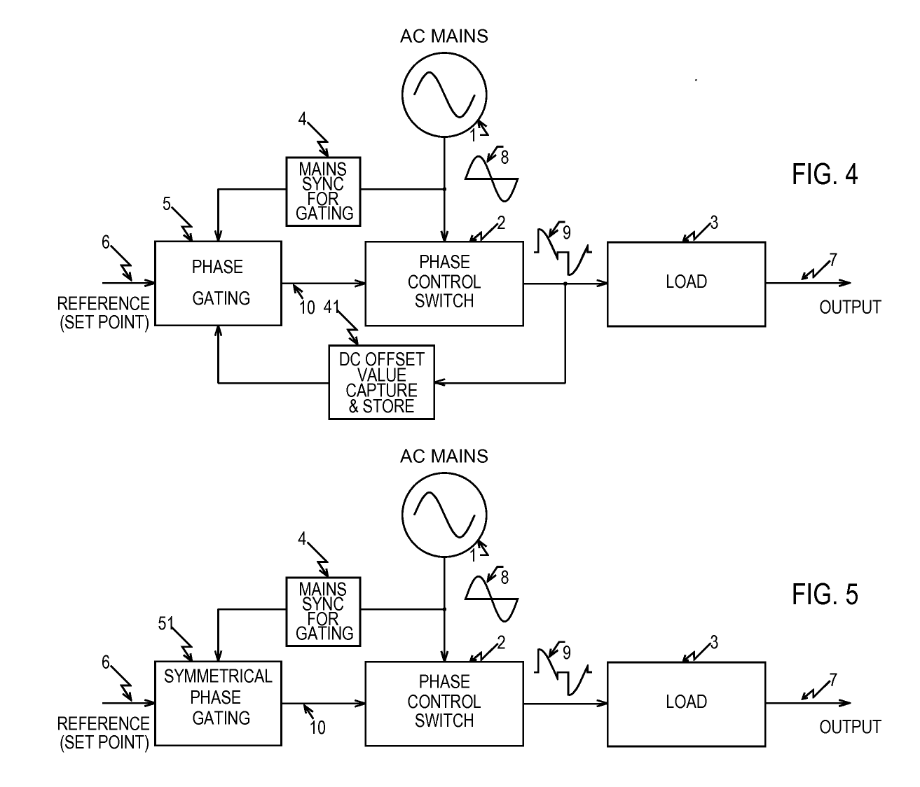

FIG. 4 is a block diagram of an embodiment of the invention, implementing Unbalance Correction using DC Offset Information in the prior art circuit of FIG. 1 via a ‘DC Offset Value Capture and Store block 41 which provides information to modify phase gating block 5. Block 41 functions by measuring and adding positive and negative half cycles, yielding any difference as DC offset, storing this difference and using it to appropriately alter the turn-on signal 10 in respect of subsequent half cycles, to reduce any unbalance in phase control switch 2 to load 3.

FIG. 5 is a block diagram of a further embodiment of the invention, implementing Unbalance Correction using gating symmetry via symmetrical phase gating block 51. Block 51 functions to make the timing of the gate signal 10 to phase control switch 2 identical in both positive and negative half cycles of the AC waveform.

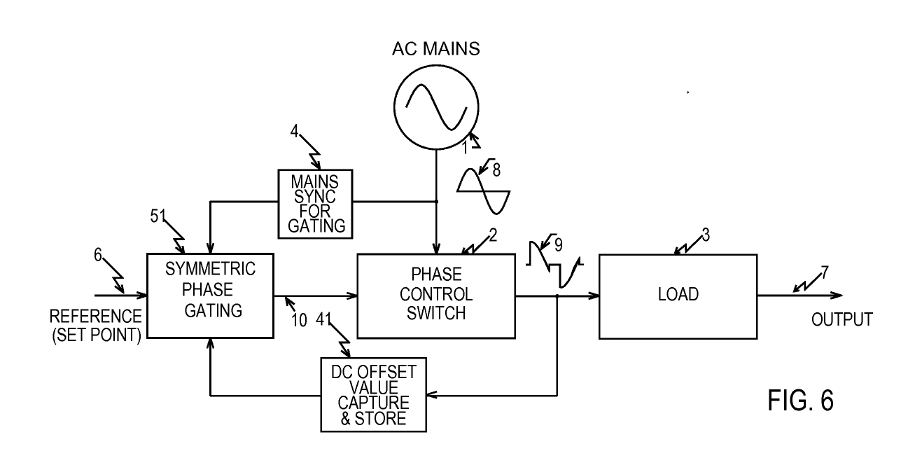

FIG. 6 is a block diagram of an embodiment of the invention, implementing Unbalance Correction using Offset Correction and Gating Symmetry, with the addition of Block 41 “DC Offset Value Capture & Store” block 41 being used to modify “symmetrical phase gating” block 51. Combining the function of the embodiments shown in FIGS. 4 and 5 produces a robust method which, when properly set, efficiently removes virtually all DC offset in an AC load driven by a phase control switch type controller over the complete voltage and temperature range of the components.

FIG. 7 is a schematic diagram of a prior art operational blower control presented with the blocks of FIG. 1 shown as dashed blocks surrounding the enabling electronic components listed below. For a system designed to operate on 120V at 60 Hz, for example as shown a PSC 120V at 60 Hz, 5 A 1560 rpm motor 79 to drive a 330 cfm blower 80, referring to the diagram, representative values of:

| | | | |
|---|---|---|---|
| 71 | AC Line | 120 V “hot” | |
| 72 | AC Neutral | 120 V “neutral” | |
| 73 | AC Line | Triac 74 to Motor 79 | |
| 74 | Triac | BTA08 8A TO220 package | (various manufacturers) |
| 75 | Resistor | 3 Kohm ¼ watt | (various manufacturers) |
| 76 | Variable | 250 Kohm ½ watt, | (various manufacturers) |
| | resistor | | |
| 77 | Diac | DB3 (32 V ± 2 V) | (various manufacturers) |
| 78 | Capacitor | 470 nF 100 VAC Film | (various manufacturers) |

Arranging the circuit of FIG. 7 by choosing diac 77 at the outer limits of asymmetry, as listed (34V one direction, and 30V reverse direction), caused the DC offset voltage to be in excess of 2 volts as outlined above. The electrical output waveforms of the FIG. 7 circuit function are illustrated in FIG. 2 at half power output.

FIG. 7 shows diac 77, by example without limitation, as a means of implementing the gate trigger 5. There are many other options for triggering the gate voltage, including without limitation silicon bilateral switches, neon lamps, unijunction transistors with pulse transformers, magnetic amplifiers, and silicon unilateral switches with opto-isolators, to name a few by way of further examples.

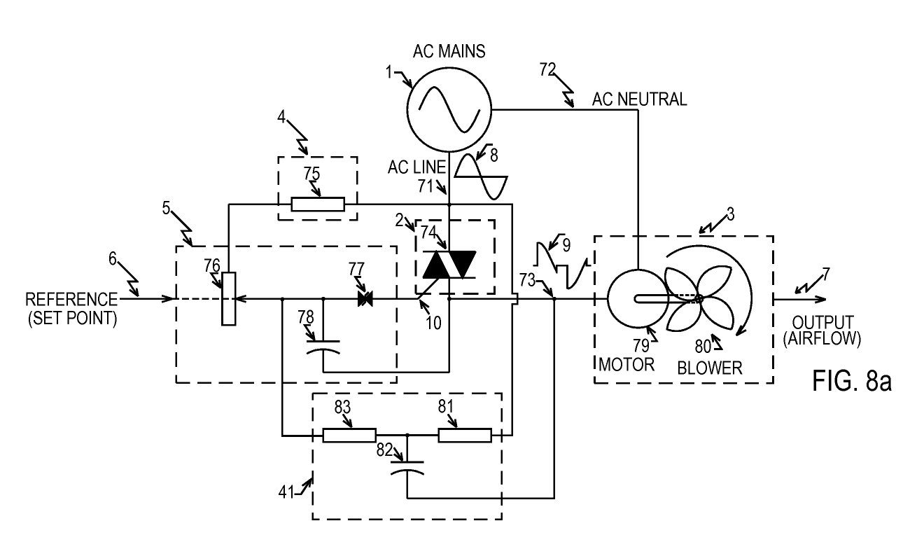

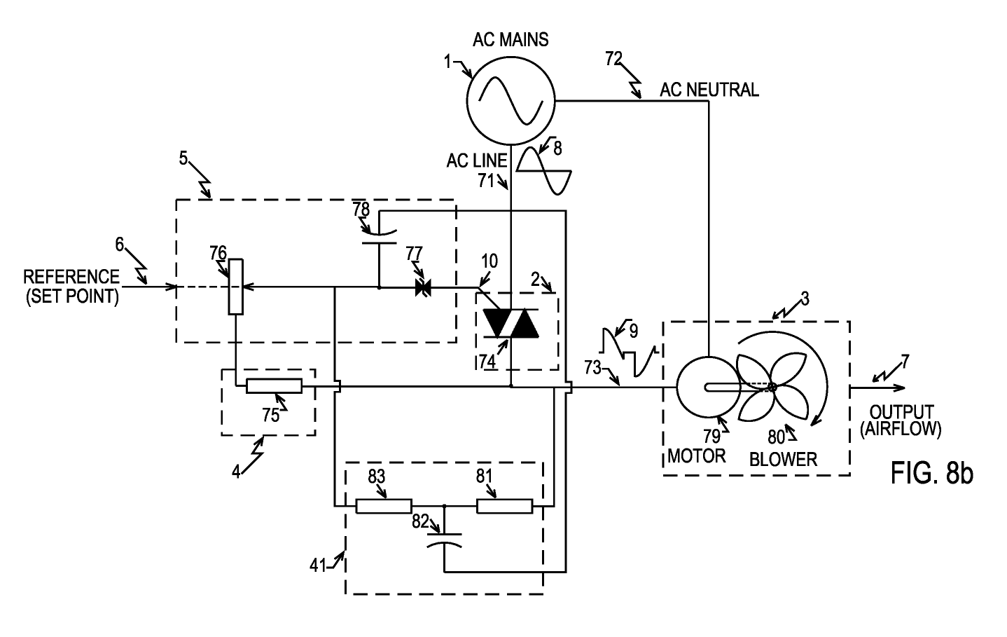

FIGS. 8a and 8b are schematic diagrams of unbalance correction using phase control switch voltage information, similar to the embodiment of FIG. 7 but with the addition of ‘DC Offset Value Capture and Store’ block 41. DC Offset Value Capture and Store block 41 circuitry in the embodiments illustrated comprises:

| | | | |
|---|---|---|---|
| 81 | Resistor | 20 Kohm 1 watt | (various manufacturers) |
| 82 | Capacitor | 220 nF 100 VAC Film | (various manufacturers) |
| 83 | Resistor | 75 K ohms ¼ watt | (various manufacturers) |

FIG. 8b illustrates a circuit for unbalance correction using phase control switch voltage information with the phase control switch polarity reversed from that in FIG. 8a. This reversal of the phase control switch makes no difference to the operation of the invention.

With the circuit of block 41 the DC offset is reduced in the output to the load over the complete range of operation typically seen in motor speed controls of between a “full-output” of 118 VAC down to 60 VAC over a temperature range of −10° C. to +55° C. In testing done over several months with “worst case” combinations of DIACs and TRIACs the DC offset voltage was reduced to less than the requirements of UL 1917. In addition, when a narrower voltage range was required, adjustment of the values of resistors 81, 83 and capacitor 82 improved the effectiveness over the narrower range.

The circuit of FIGS. 8a and 8b functions by measuring the voltage across the switch 2 which, in a symmetrical mains supply, provides the inverse of the DC offset presented to the load 3. This inverse of load DC offset is measured and stored by the block 41 containing the combination of resistor 81, capacitor 82 and resistor 83. Resistor 83 then feeds a current proportional to the stored DC offset value to phase gating capacitor 78, altering its charging and thus the time to gate trigger. This alteration in gate trigger time is in a direction to reduce the DC offset in the load 3.

As the on-time in the embodiments of FIGS. 8a and 8b decreases from the maximum “on-time” at 118 VAC to the minimum “on-time” at, for example, 60 VAC, the amount of DC offset increases non-linearly. The embodiments of the invention illustrated in FIGS. 8a and 8b are responsive to the “on-time” effect on DC offset, and actually adjust the DC offset correction amount beneficially to compensate as the AC output voltage decreases. The circuits of FIGS. 8a and 8b also operate to eliminate the DC offset which results from a turn-off time difference of 2 between positive-going and negative-going current in line commutated switches. These circuits adjust the on-time appropriately to correct differences in turn-off between positive and negative half cycles.

The variation of turn-on time of the diac 2 after gating is not usually significant as between positive and negative half cycles, but the circuit of block 41 operates to correct if necessary by the process outlined above. While this circuit is effective in reducing DC offset, it does not accomplish the task of virtually eliminating DC Offset.

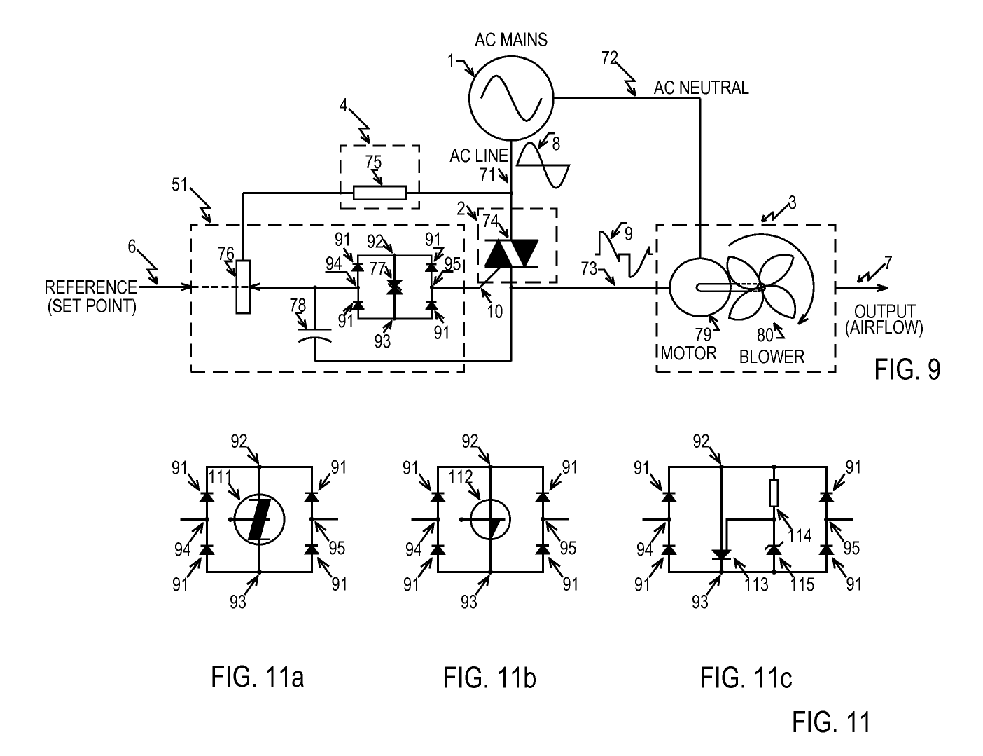

FIG. 9 illustrates an embodiment providing unbalance correction using gating symmetry in a variation of the embodiment of FIG. 7, by adding four diodes 91 (1N4148 from various manufacturers) in a bridge configuration around DIAC 77 with nodes, identified as 92, 93, 94 and 95, as follows:

| | | |
|---|---|---|
| 92 | node | positive rectifier |
| 93 | node | negative rectifier |
| 94 | node | first rectifier input |
| 95 | node | second rectifier input |

This circuit works by assuring that only one direction of the diac 77 is utilized by the phase gating circuit, and thus only one breakover voltage operates at the ‘turn on’ voltage regardless of the direction of charge of capacitor 78. This means that any asymmetry in the diac 77 breakover voltages no longer contributes to the production of DC offset to the load. There is a minor amount of asymmetry brought on by the two different pairs of diode 91 used in the opposite direction of operation. Testing with actual controls showed the asymmetry brought on by diode differences to be virtually unmeasurable at less than 3 millivolts in 32 volts over the full temperature range of the load 3. However this and other sources of asymmetries such as phase control switch 2 turn-off can result in up to one percent values of DC offset.

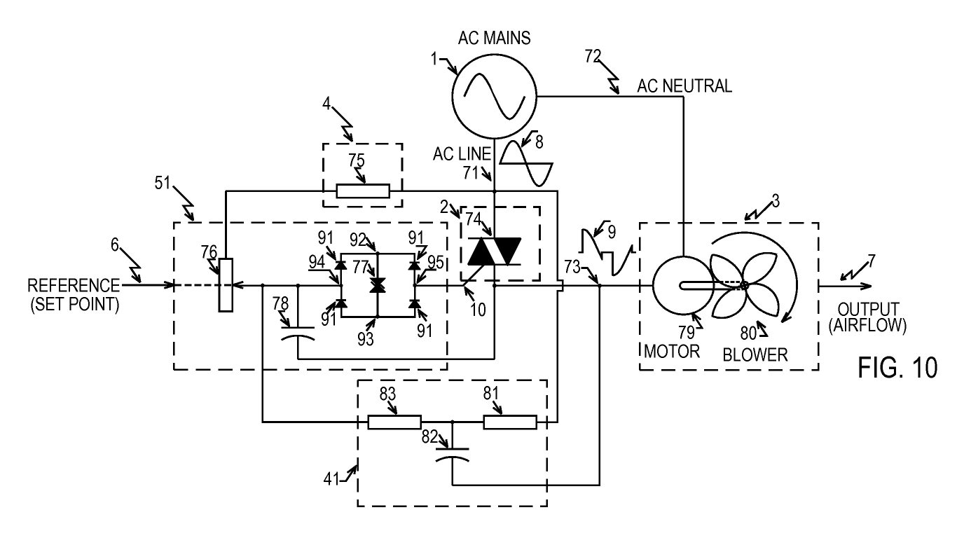

FIG. 10 is a schematic diagram of a variation of FIG. 9 implementing unbalance correction using both switch voltage information and gating symmetry, achieved adding to FIG. 9 ‘DC Offset Value Capture and Store’ block 41 containing resistors 81, 83 and capacitor 82. This combined embodiment ensures that any asymmetries will be compensated out regardless of their origin in a controller (with undamaged components) throughout their operating voltage and temperature ranges. In testing this embodiment reduced the DC offset voltage to tens of millivolts, which translates to DC offset current of tenths of milliamperes over a range of 118 VAC down to 30 VAC throughout the temperature range of −10° C. to +55° C. Moreover, this performance can be achieved without pre-selection of components other than utilizing those within their ordinary data sheet tolerances.

The minimum cost involved in adding 4 diodes, 2 resistors and 1 capacitor of values revealed to the existing design of the PCSTAC controller is readily apparent.

Further variations in this design are presented below to illustrate other means of accomplishing some or all of the results outlined in respect of the above embodiments.

FIGS. 11a to 11c are schematic diagrams showing alternate methods of achieving symmetrical trigger devices, by way of example and without limitation. In FIG. 11a a bilateral switch 111 (MBS4991, various manufacturers) replaces diac 77 inside the diode bridge. In FIG. 11b a unilateral switch 112 (NTE6404, various manufacturers) replaces diac 77 inside the diode bridge. In FIG. 11c a programmable unijunction transistor (PUT) 113 (2N6028, various manufacturers) with resistor 114 (22 Kohm ¼ watt, various manufacturer) and Zener diode 115 (1N5252, various manufacturers) replaces DIAC 77 within the diode bridge. In addition to these variations, many hybrid structures including a two-bipolar transistor design, a microcontroller with suitable firmware, or an application specific integrated circuit (ASIC) could all be made to behave as required for the gate trigger function.

The explicit assembly is not important, but the requirement contemplated is for this circuit segment to behave in an exactly or substantially exactly symmetrical manner for both the positive and negative half waves of the AC cycle.

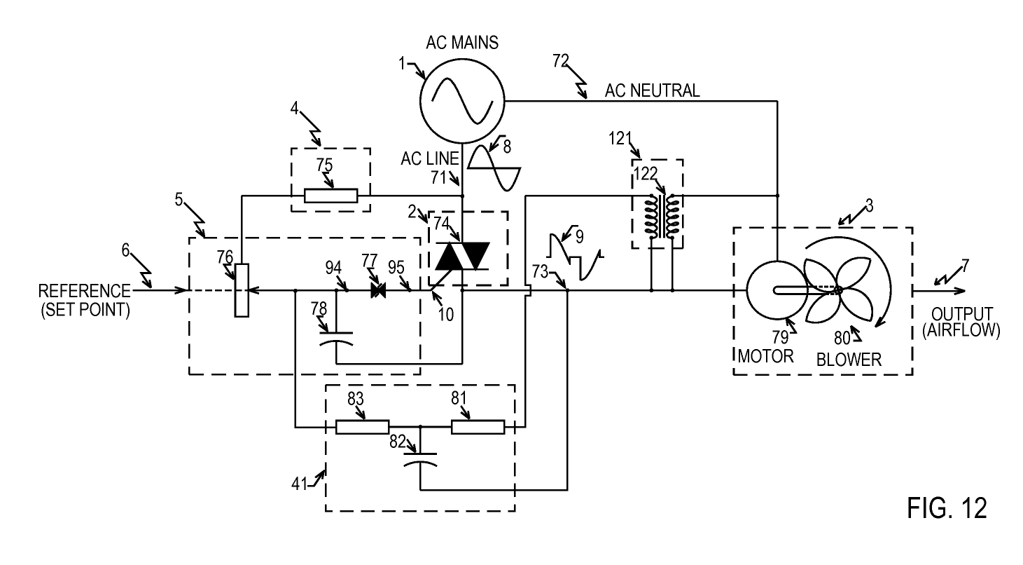

FIG. 12 illustrates an embodiment of the invention wherein the DC offset information is obtained from measurement of voltage across the load 3. In this circuit the embodiment of FIG. 10 is modified by interposing a voltage-to-voltage transducer 121 comprising transformer 122 (120V/120V, 4VA) between the ‘DC Offset Value Capture and Store’ block 41, via resistor 81, and the voltage across the load 3 is measured at the output of transducer 121. This circuit measures the DC Offset across the load 3 directly, but has the additional cost of an extra conductor between the neutral 72 and the PCSTAC controller. Under certain circumstances this extra conductor may be already be present, performing for some other function, for example line transmitted noise reduction, in which case no additional cost would be incurred.

A variation of the transducer 121 could include an opto-isolator with transistor output or an opto-isolator with photovoltaic output and suitable modification of block 41. The exact mechanization of the transducer 121 is not critical, only that it faithfully delivers a signal that can be utilized to sensibly alter the behaviour of gate signal 10 timing.

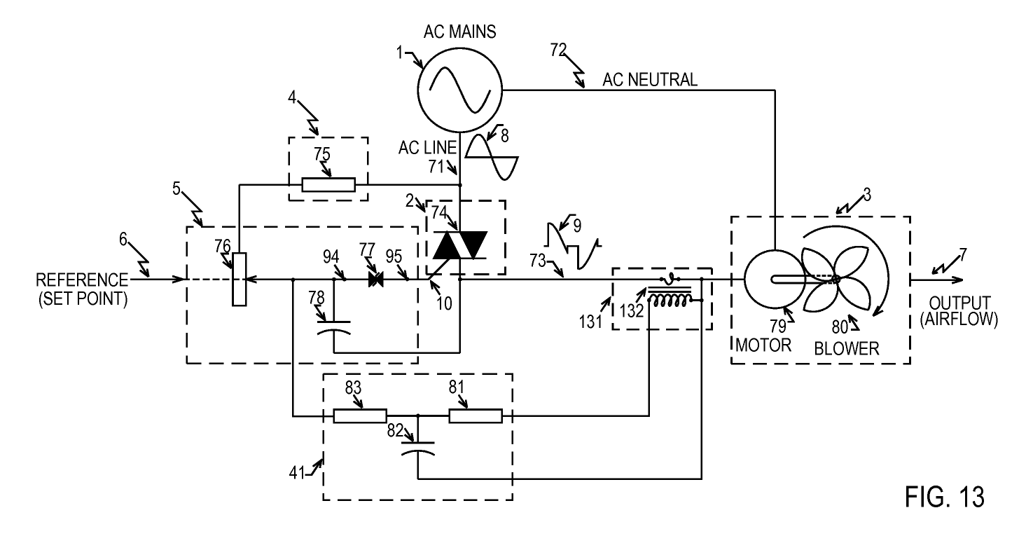

FIG. 13 illustrates an embodiment wherein the DC offset information is obtained from measurement of current flowing through the controller and hence through the load. Current-to-current transducer 131 comprising current transformer 132 (5 A/6 mA, 1VA, various manufacturers) is interposed between the ‘DC Offset Value Capture and Store’ block 41 and the output of DIAC 77, providing the DC offset information. There are a number of advantages to this embodiment. First, the circuit provides a direct measurement of the parameter that is of interest for the load and the mains: DC Offset current. Second, as current flow is being used for reference, the value for DC offset is simple a summing function without need to keep track of small negative “positive” signals and vice versa. This permits improved functionality of block 41. Third, the wiring is kept simple since the entire function can be achieved within the PCSTAC controller.

A variation of transducer 132 could include a resistor shunt (say 0.3 ohm, not shown) in line 73 along with adjustments to block 41 to include an operational amplifier and suitable resistors and capacitors to store and adjust the charging of capacitor 78. Another variation of transducer 132 could use a Hall effect transducer (not shown) for the shunt. The exact mechanization of the transducer 132 is not critical, only that it faithfully delivers a signal that can be utilized to sensibly alter the behaviour of gate signal 10 timing.

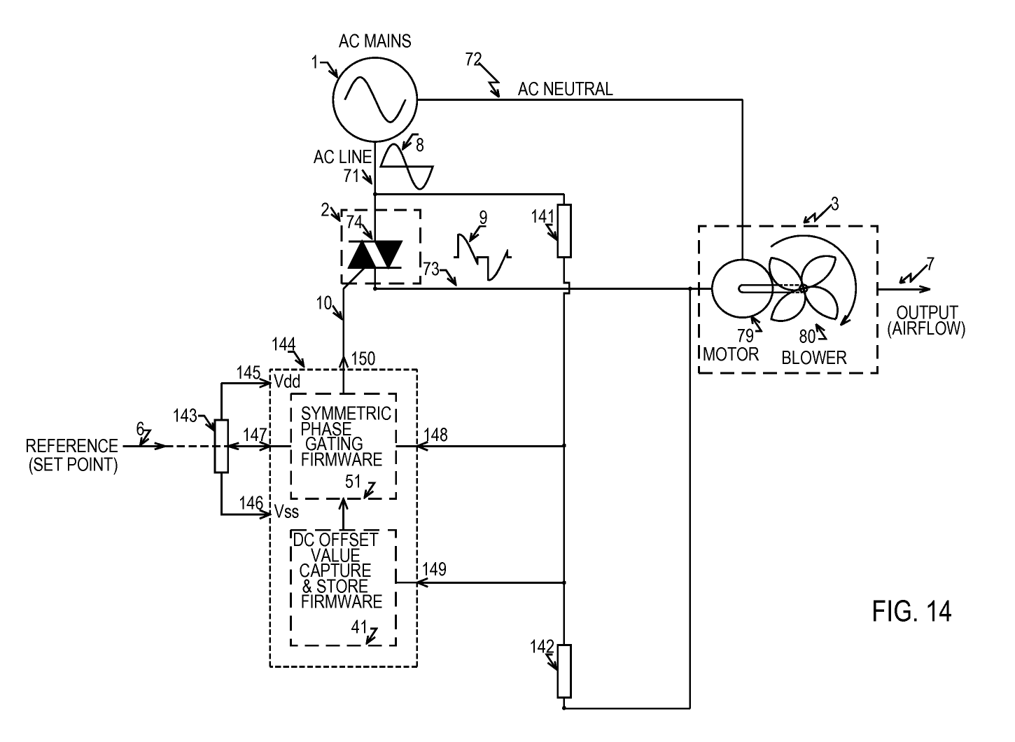

FIG. 14 is an embodiment incorporating a microcontroller wherein the DC offset information is obtained by measuring voltage across phase control switch 2. The components illustrated are as follows:

| | | | |
|---|---|---|---|
| 141 | Resistor | 200 Kohm ¼ watt | various |
| | | | manufacturers |
| 142 | Resistor | 3.57 Kohm ¼ watt | various |
| | | | manufacturers |
| 143 | Potentiometer | 500 Kohm ¼ watt | various |
| | | | manufacturers |
| 144 | Microcontroller (uC) | PIC16F676 | Microchip |
| | | | Technology |
| | | | Incorporated |
| 145 | uC Positive Supply Pin | | |
| 146 | uC Negative Supply Pin | | |
| 147 | uC Reference in Pin | | |
| 148 | uC AC synchronization Pin | | |
| 149 | uC DC Offset Information | | |
| | Pin | | |
| 150 | uC Output Pin | | |

This embodiment is analogous to that of FIG. 10. The power supply for the microcontroller is not shown for simplicity. It is 5 VDC, and is mechanized by using the small ‘off’ times of a PCSTAC controller near zero volts during each cycle as, generally described in U.S. Pat. No. 4,504,778 to Evans, which is incorporated herein by reference. All information for this embodiment might alternately enter via a single pin 148, with suitable microcontroller firmware controlling the flow to the ‘DC Offset Value Capture and Store’ block 41, and symmetrical gating block 51.

As can be seen from FIG. 14, the number of components used in this realization of the PCSTAC controller is minimal, because the functionality of blocks 4, 41 and 51 (in FIG. 1) are included in the firmware of microcontroller 144 and the cost of these components is thereby avoided.

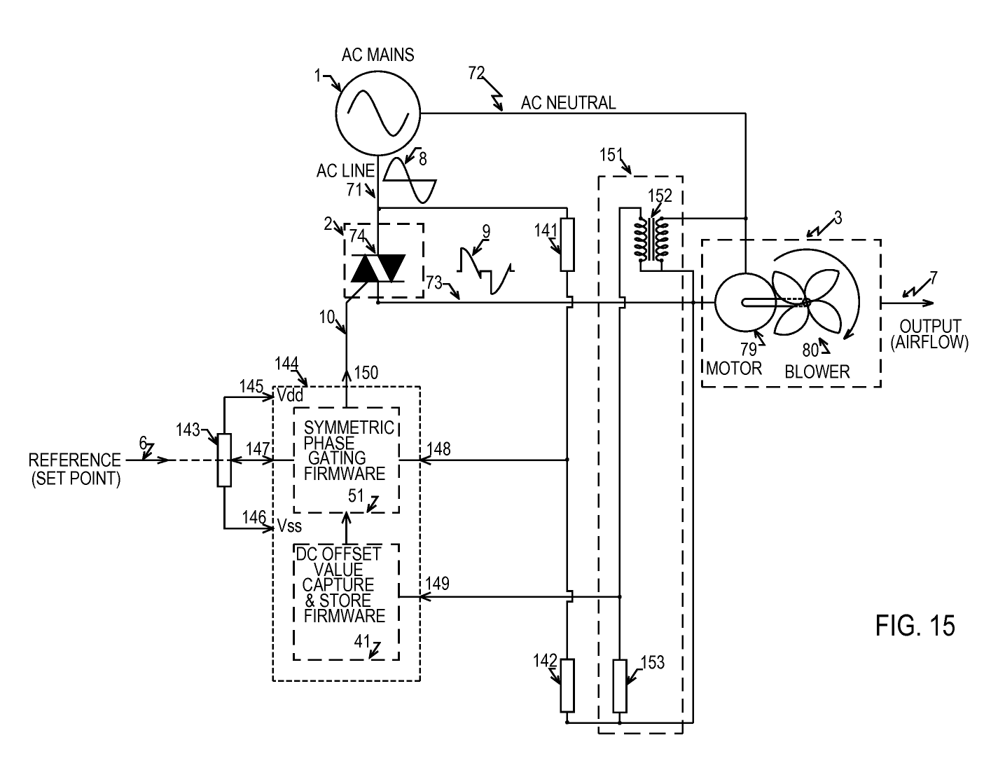

FIG. 15 illustrates an embodiment incorporating a microcontroller 144 whereby the DC offset information is obtained by measuring voltage across the load 3. This embodiment is analogous to that of FIG. 12, and can be obtained by adding voltage-to-voltage transducer 151 to FIG. 14 and changing the connection of pin 149 to 151 as shown. Transformer 152 (120V/1.2V, 1VA, various manufacturers) and resistor 153 (3.57 Kohm, ¼ watt, various manufacturers) provide the DC offset information. This embodiment otherwise operates similarly to that of FIG. 12. However, the voltage transducer 151 in this embodiment permits a feedback control loop to be implemented to maintain the output voltage to the motor 79 independent of changes in the mains voltage. This is a desirable function, as it approaches a closed loop feedback control system as outlined above, but at a one-time cost of the additional firmware for the microcontroller.

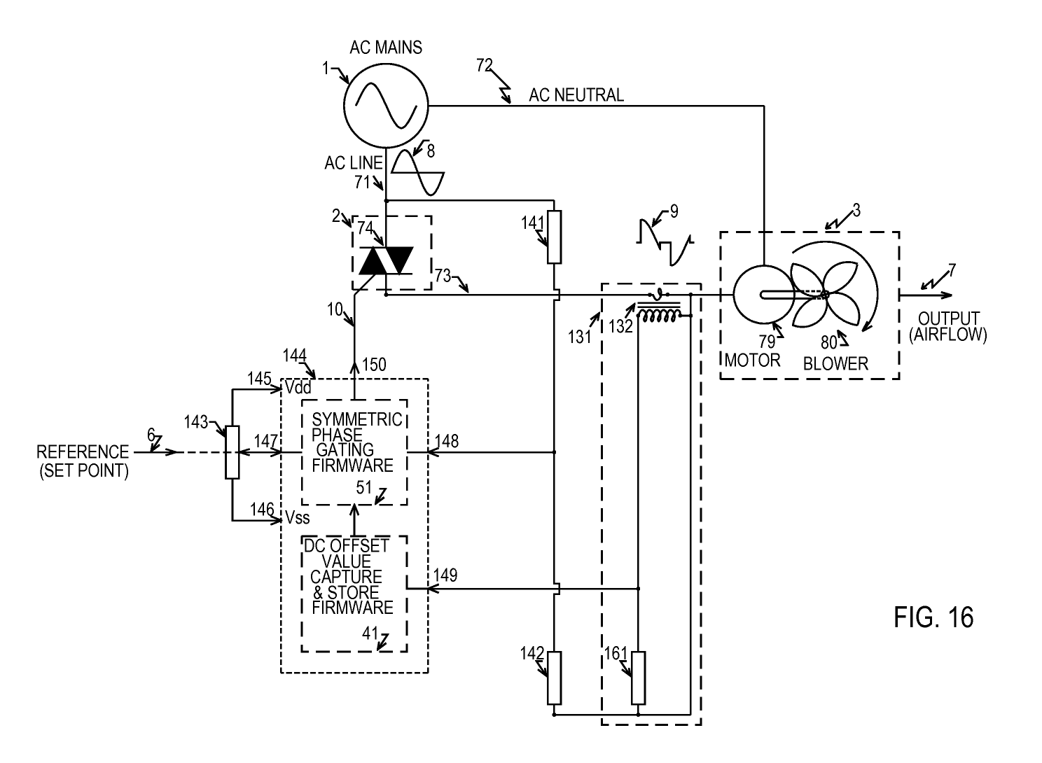

FIG. 16 is an embodiment incorporating a microcontroller wherein the DC offset information is obtained by measuring current through the control to load 3. This embodiment is analogous to that of FIG. 13. The embodiment is obtained by adding to FIG. 14 a current-to-current transducer 131 comprising current transformer 152 (5 A/6 mA, 1VA, various manufacturers) and resistor 161 (750 ohms, ¼ watt, various manufacturers) provides the DC offset information, and changing the connection of pin 149 to the transducer 152. As current flow is being used, the firmware in the microcontroller for DC offset is simple a summing function without need to keep track of small negative “positive” signals, and vice versa. This embodiment otherwise operates similarly to the embodiment FIG. 13.

The current transducer 151 in this embodiment allows for a feedback control loop to be implemented, to maintain the output current to the motor independent of changes in the mains voltage. This is a desirable function as it approaches a closed loop feedback control system as outlined above, at a one-time cost of additional firmware for the microcontroller 144.

The introduction of a microcontroller, as in the embodiments of FIGS. 14, 15 and 16, enables many other functions to be readily incorporated into a PCSTAC controller. This could include deriving DC offset values via other means such as harmonic analysis of the waveforms, analysis of power flow or adding constant power, voltage, or current delivery to the load 3 as a closed loop feedback function. Such additional functionality is contemplated within the scope of the invention.

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. A method for diminishing a DC offset in an AC load driven by a phase control switch type alternating current controller comprising a phase control switch and a phase gating device, comprising the steps of:
a. obtaining information representing DC offset present in the load;
b. storing a value representing the DC offset; and
c. adjusting the controller to lower the DC offset in the load by applying a correcting signal to the phase gating device to thereby adjust phase gating timing to approach a substantial match between the power in the positive and negative half cycles of the load supply.

2. A phase control switch type alternating current controller circuit for diminishing an amount of DC offset present in a load, comprising:
a phase controlled switch comprising a TRIAC having:
a first electrode connected to an AC power supply and through an AC supply synchronizing component to a gating device comprising a variable resistor,
a second electrode connected through a DIAC to a first side of the variable resistor and hence through the other side of the variable resistor to the AC supply synchronizing component to the first electrode, and
a third electrode connected through a capacitor to the second electrode via a node between the DIAC and the first side of the variable resistor and to an input of the load, and
a feedback circuit for obtaining and storing a value representing the DC offset, having inputs connected to the first electrode and to the input of the load and an output connected to the first side of the variable resistor,
whereby timing of the gate signal causes positive and negative half cycles of the load power to be substantially identical and hence diminishes the DC offset.

3. A phase control switch type alternating current controller circuit for diminishing an amount of DC offset present in a load, comprising:
a phase controlled switch comprising a TRIAC having:
a first electrode connected to an input to a load and through an AC supply synchronizing component to a gating device comprising a variable resistor,
a second electrode connected through a DIAC to a first side of the variable resistor and hence through the other side of variable resistor to the AC supply synchronizing component to the first electrode, and
a third electrode connected through a capacitor to the second electrode via a node between the DIAC and the first side of the variable resistor and to an AC power supply, and
a feedback circuit for obtaining and storing a value representing the DC offset, having inputs connected to the first electrode and to the input of the load and an output connected to the first side of the variable resistor,
whereby timing of the gate signal causes positive and negative half cycles of the load power to be substantially identical and hence diminishes the DC offset.
